(19) United States
(12) Patent Application Publication
(10) Pub. No.: US 2015/0178856 A1
(43) Pub. Date: Jun. 25, 2015

(54) System and Method for Collecting and Submitting Tax Related Information

(71) Applicant: Alfredo David Flores, El Paso, TX (US)

(72) Inventor: Alfredo David Flores, El Paso, TX (US)

(21) Appl. No.: 14/577,850

(22) Filed: Dec. 19, 2014

Related U.S. Application Data
(60) Provisional application No. 61/918,897, filed on Dec. 20, 2013.

(51) Int. Cl. G06Q 40/00; G06Q 10/10; G06Q 30/02

(52) U.S. Cl. CPC G06Q 40/123; G06Q 30/0207; G06Q 10/1095

(57) ABSTRACT

A method for submitting and receiving information required for tax filing contains a mobile interface and a website interface. A client submits information through the mobile interface. Personal information and digital photographs of at least one identification card and received tax documentation are submitted by the client through a client account. Required tax information is extracted from the digital photographs submitted by the client account. The personal information and the required tax information are stored on a secure server. A tax preparer accesses the secure server through a tax preparer account. More specifically, the tax preparer account accesses the secure server through the website interface. When the personal information and the required tax information are reviewed and edited by the tax preparer account, the tax preparer account can proceed with the tax filing process through the website interface.

The current application claims a priority to the U.S. Provisional Patent application Ser. No. 61/918,897 filed on Dec. 20, 2013.

### FIELD OF THE INVENTION

The present invention relates generally to software applications designed for collection and submission of information to organizations such as companies. More specifically, the present invention is an information collection and submission application which is specifically designed to collect information from users and submit that information to a company for analysis. The preferred embodiment of the present invention is focused upon the collection of information pertaining to taxes which are paid to the government.

### BACKGROUND OF THE INVENTION

The modern global economy functions primarily upon the concept of free markets in which goods and services are exchanged on a daily basis. Most modern free markets utilize the concept of currency as a medium for trades. Typically, goods and services are exchanged for some amount of currency; currency which can later be exchanged for other goods and services. Thus, currency serves as an effective medium for the exchange of goods and services. The value of currency fluctuates on a daily basis and is based largely upon the relative worth of items purchased and the amount of currency required to purchase the item. All entities which operated within a capitalistic free market economy must utilize currency in some capacity in order to make purchases of items or services which are essential to the continued survival of that entity. Individuals must purchase food, utilities, and other items needed for base survival. Organizations such as companies typically must purchase facilities, equipment, and the work of employees who keep the company running. Even governments must utilize currency in order to fund projects, pay government employees, and purchase new military hardware for defense of the nation's sovereignty. In many ways, the government of countries needs currency even more so than its people as governments are responsible for maintaining order and regulations which are critical to the continued existence of the country as a whole entity. On the opposite side of the same argument it is necessary that individual citizens have enough wealth to support themselves and as such it is important that the government not strip its citizens of an excessive amount of currency simply to support itself.

The primary mode of governments obtaining funding from its citizens is known as taxation. Taxation involves the collection of a portion of each citizen's yearly income in order to fund government operations. In the United States, this tax is typically taken out of a person's paycheck immediately. There are also a number of other taxes which must be adhered to, some of which are not paid in their entirety automatically. For this reason it is necessary for a person to file tax return forms during a specific time period of each year. In many cases the government has overcharged an individual and will return a portion of the taxed income or otherwise to the person. In other cases a person has not been fully taxed and will owe the government additional money. It is important that a person file their tax returns correctly in order to ensure that they are not audited by government agencies later in life; the primary agency responsible for taxes being the Internal Revenue Service or IRS for short.

As with most government operations, tax returns have a tendency to be overcomplicated and difficult to fully understand. This is particularly true for someone with a full time job who cannot dedicate extensive amounts of time to understanding the process in its entirety. For this reason, there is a plurality of companies which have been established over the years to provide tax return filing services for customers who pay a minimal fee to have their tax returns completed and filed by a professional. When a person engages such a service it is only necessary for the user to provide the company with various different completed governmental tax forms such as a W-2 form. The company then uses this information and completed forms to complete a tax return and file it with the federal and state governments. Such services typically boast high degrees of accuracy, maximum tax returns, and maximum convenience for their customers. Such characteristics have made tax filing services extremely popular to those who are very busy during the day such as employed professionals. Traditionally, customer information and tax return forms are submitted to such service companies physically. However, over the years, technology has advanced to a level where it is possible to submit information and files to a company through digital means. Such a process is far more advantageous for the customer as they no longer have to visit the company in person and can instead provide the information remotely. For a large company with hundreds of customers, it is imperative that a method be in place for streamlining an efficient reception of a large volume of customer information to be used in filing tax returns.

Resultantly, it is an object of the present invention to create an information collection and submission application which is capable of accepting information from users in an organized manner and then allowing representatives of tax return companies to retrieve that information for use in filing tax returns. It is an object of the present invention to provide an application which can be run on a mobile device such as a smart phone such that the user of the present invention is afforded with convenience. It is a further object of the present invention to allow for organized collection of information through various different templates for official tax return forms. It is a further object of the present invention to allow for attachment of various different media files such as pictures of the official forms. It is a further object of the present invention to allow for tax preparer companies to receive the information which is collected by the present invention. Thus, the present invention serves as a way for tax preparer companies to easily and effectively receive information from customers.

### BRIEF DESCRIPTION OF THE DRAWINGS

FIG. 1 is a basic flowchart illustrating the basic overall method of the present invention.

FIG. 2 is a basic flowchart illustrating the process of generating the encrypted submission identification number.

FIG. 3 is a basic flowchart illustrating the process of decrypting and displaying the submission identification number.

FIG. 4 is a basic flowchart illustrating the process of reviewing and editing completed by the tax preparer account.

FIG. 5 is a basic flowchart illustrating the process of updating the preparer profile through the backend interface.

### DETAIL DESCRIPTIONS OF THE INVENTION

All illustrations of the drawings are for the purpose of describing selected versions of the present invention and are not intended to limit the scope of the present invention.

The present invention is a method for submitting and receiving information required in the tax filing process. More specifically, the present invention allows a tax payer to conveniently submit information required for tax filing. On the other hand, the tax preparer promptly receives information in order to proceed with the tax filing process. Additionally, the present invention allows the tax preparer to complete the tax filing process at a minimal cost since the efficiency in filing is improved.

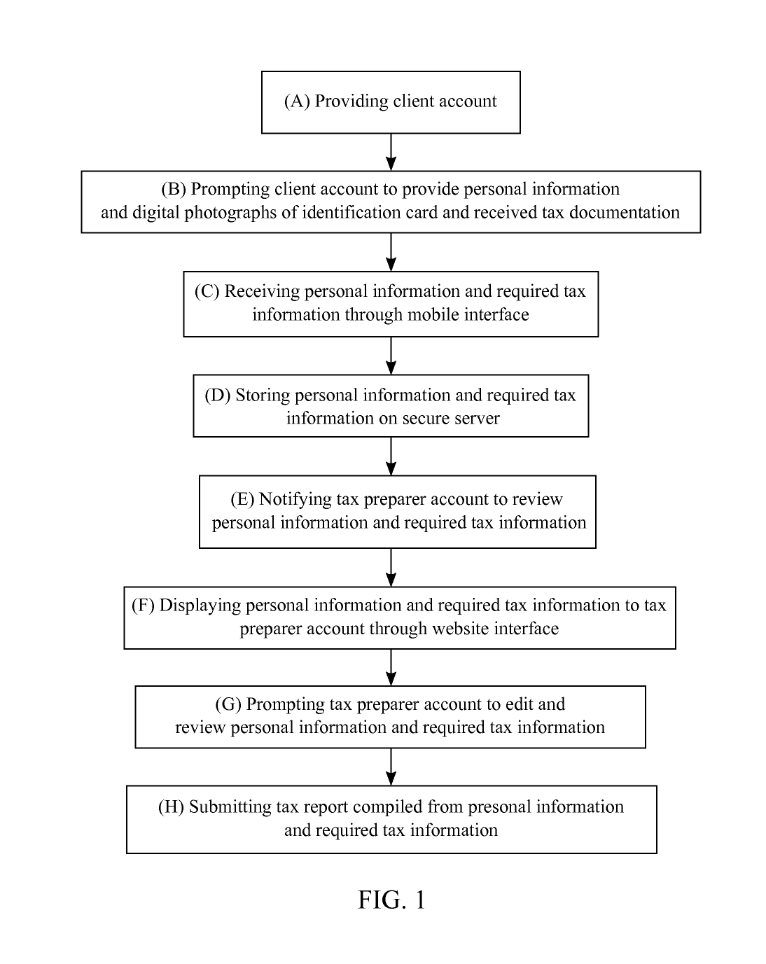

FIG. 1 illustrates the basic overall process of the present invention. In order to complete the tax filing process through the present invention, a client is provided with a client account. All information required for the tax filing process is submitted through the client account. A mobile interface of the present invention allows the client to submit information through a mobile device within a short period of time. Similarly, the tax preparer is provided with a tax preparer account. The tax preparer account allows the tax preparer to receive necessary information from the client account in order to complete the tax filing process. In order to do so, the tax preparer account accesses the information submitted by the client account through a website interface. The website interface allows the tax preparer account to proceed to filing the tax return. In the process of providing the necessary information to the tax preparer, the information submitted by the client account is initially saved on a secure server. The secure server serves as an accessible database for both the mobile interface and the website interface. In order to do so, the mobile interface and the website interface are communicably linked through the secure server. As a result, the tax preparer account can conveniently access information stored on the secure server through the website interface.

As mentioned earlier, the tax filing process is initiated when the client submits necessary information through the client account. In order to do so, the present invention prompts the client account to enter personal information that is essential to the tax filing process. Information such as, the client's name, date of birth, social security number, filing status, spouse information, and number of dependents is provided as the personal information. Once the process is complete, the personal information is received through the mobile interface and stored on the secure server. Once the personal information is received, the present invention prompts the client account to submit at least one identification card and any received tax documentation as digital photographs. A digital photograph of the client's driver's license and the client's social security card is accepted as identification information for the at least one identification card. Meanwhile, a digital photograph of the wage and tax document, commonly known as the W-2 form, is accepted as the received tax documentation. Other documents such as the miscellaneous income form (1099 form), the mortgage interest statement (1098 form), and child care information form are also accepted as the received tax documentation if applicable to the client account. Similar to receiving and storing the personal information, the digital photographs of the at least one identification card and the received tax documentation are also received through the mobile interface, and stored on the secure server. After uploading the personal information, the digital photographs of the at least one identification card, and the received tax documentation, the client account submits all information to the tax preparer account as a final submission step.

The tax preparer account proceeds with the tax filing process using the content available in the personal information and the digital photographs of the at least one identification card and the received tax documentation. In order to extract required tax information, the present invention scans the digital photographs of the at least one identification card and the received tax documentation. After the required tax information is extracted, the required tax information along with the personal information is made available to the tax preparer account through the web interface. In order to prompt the tax preparer account to review the personal information and the required tax information, the present invention notifies the tax preparer account via a notification. In the preferred embodiment of the present invention, the tax preparer account is notified via an electronic mail. The notification is especially important at times when the tax preparer account has a large number of cases to review. In other words, the notification serves as a reminder for each client account that submitted information to the tax preparer account through the present invention.

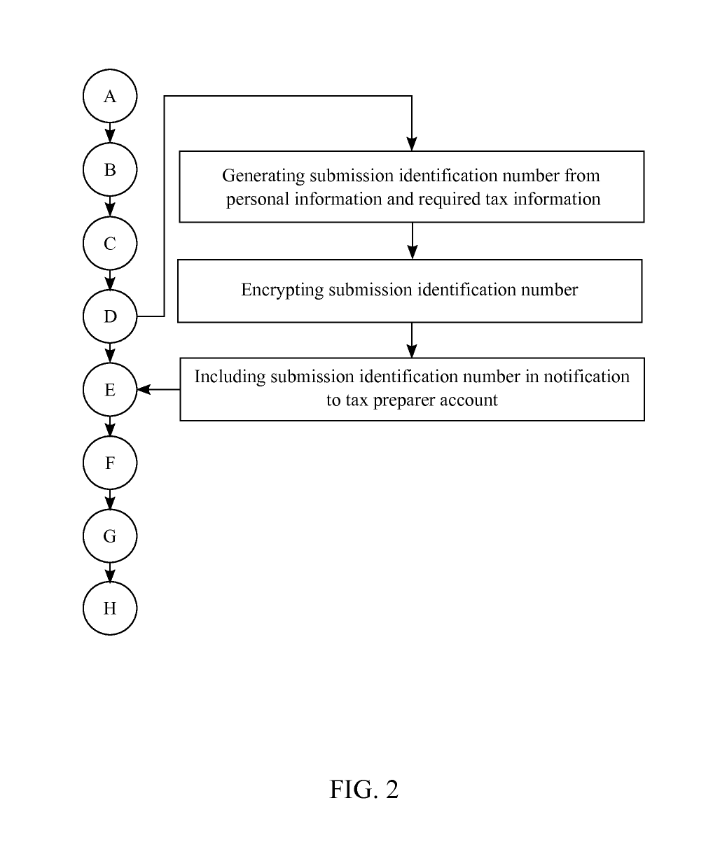

As illustrated in FIG. 2, an encrypted submission identification number is forwarded along with the notification sent to the tax preparer account. The encrypted submission identification number is generated from the personal information and the required tax information provided by the client account. The encrypted submission identification number is important in protecting the personal information and the required tax information. More specifically, the present invention requires the tax preparer account to enter the encrypted submission identification number to access the personal information and the required tax information. Therefore, even if an outside source other than the tax preparer account obtains access to the notification, they are unable to access the personal information and the required tax information without correctly decrypting the encrypted submission identification number.

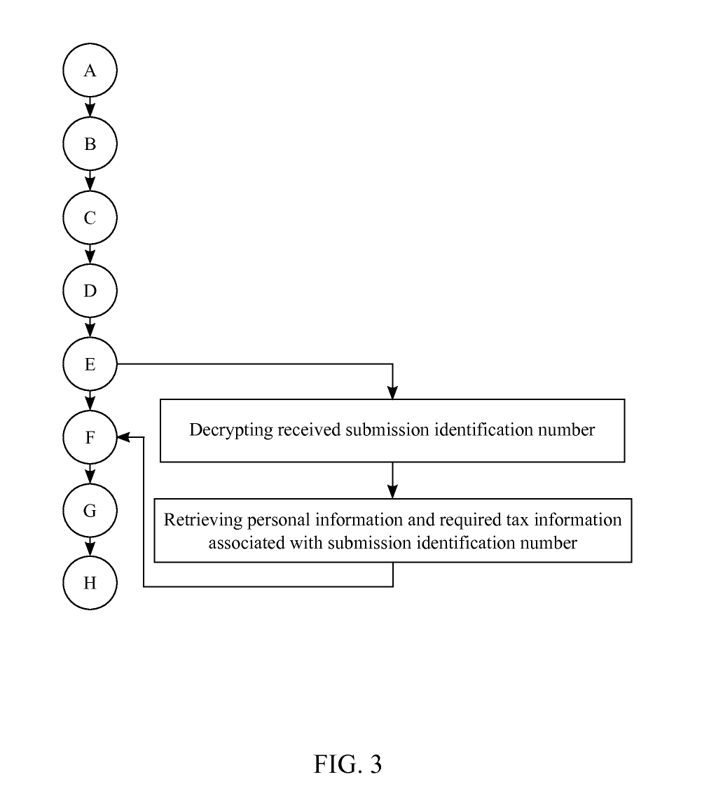

As discussed earlier, the tax preparer account is prompted to enter the encrypted submission identification number through the website interface. If entered correctly, the encrypted submission identification number gives the tax preparer account direct access to the personal information and the required tax information as illustrated in FIG. 3. When the encrypted submission identification number is received, the present invention decrypts the encrypted submission identification number. Simultaneously, the present invention verifies the encrypted submission identification number with the personal information and the required tax information. Decrypting and verifying the encrypted submission identification number ensures that the personal information and the required tax information are directly transferred from the client account to the tax preparer account. If the decrypting and verifying process is successful, the present invention retrieves the personal information and the required tax information associated with the encrypted submission identification number from the secure server. Next, the present invention displays the personal information and the required tax information that has been retrieved to the tax preparer account through the web interface, allowing the tax preparer account to proceed with the tax filing process.

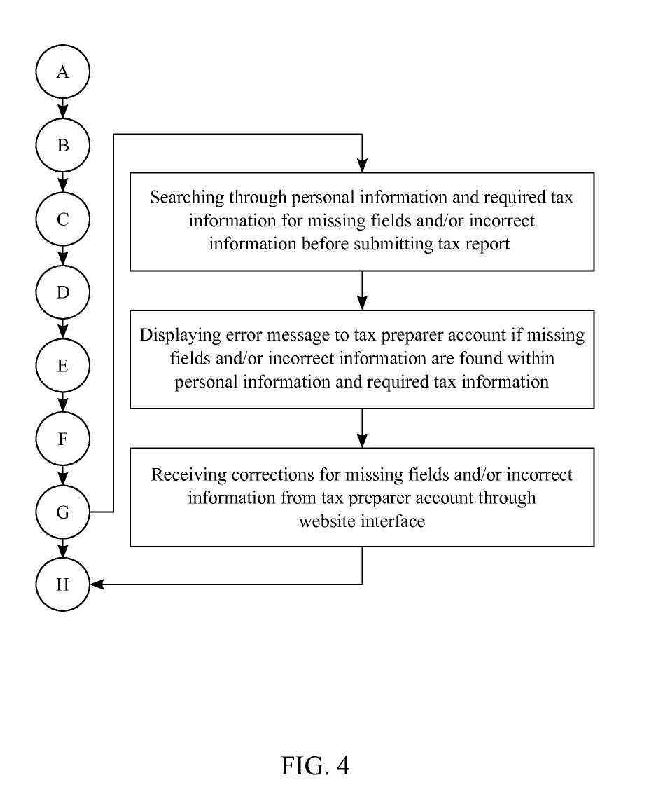

Prior to completing the tax filing process, the present invention prompts the tax preparer account to review and edit the personal information and the required tax information. The reviewing and editing process is illustrated in FIG. 4. Reviewing and editing is mandatory to ensure that the client has provided the personal information and the required tax information accurately. For the convenience of the tax preparer account, the present invention searches through the personal information and the required tax information for missing fields and/or incorrect information prior to submitting a tax report. As a result, the tax preparer is guaranteed that the client account provided all information that is mandatory to complete the tax filing process. If the client account has not provided relevant information and the personal information or the required tax information contains missing fields and/or incorrect information, the present invention notifies the tax preparer account through an error message. In the process of searching for the missing fields and/or incorrect information, the present invention compares the personal information to the required tax information. As a result of the comparison, the present invention accurately detects any existing discrepancies between the personal information and the required tax information. When the tax preparer makes the corrections, the present invention receives the corrections for the missing fields and/or the incorrect information through the web interface. As the final step, the tax preparer account submits the tax report compiled from the personal information and the required tax information. In other words, the tax report is submitted to the Internal Revenue Service department.

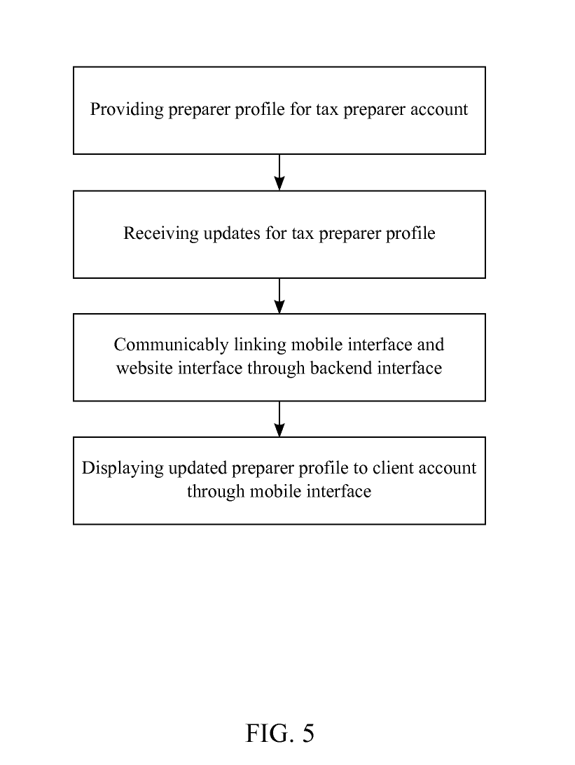

The present invention provides a preparer profile for the tax preparer account. As illustrated in FIG. 5, the preparer profile is utilized to introduce updates for the tax preparer account. In order to do so, the present invention provides a backend interface. The functionalities of the backend interface can vary according to the content management system used in the present invention. The backend interface communicably links the mobile interface and the website interface such that the preparer profile can directly introduce updates to the mobile interface through the backend interface. As an example, if the preparer profile updates the layout of the tax preparer account, the new updates are applied to the mobile interface through the backend interface.

The backend interface is generally utilized to update staff information and contact information. As an example, when updating the staff information, the preparer profile initially accesses the backend interface through the web interface. When the necessary updates are complete, the present invention receives the updates for the preparer profile through the backend interface. Next the preparer profile with the updates is displayed to the client account through the mobile interface. Since the mobile interface is communicably linked to the web interface through the backend interface, the updates from the preparer profile are directly seen by the client account. A similar procedure is followed when updating the contact information. Similar to the staff information, the updated contact information for the preparer profile is viewed by the client account through the mobile interface.

In order to improve client experience, an appointment schedule is provided for the tax preparer account. The appointment schedule allows the client to set up an appointment with the tax preparer. The appointment schedule is especially important if the client desires to meet the tax preparer in person. In order to do so, the present invention displays at least one available time period to the client account through the mobile interface. Next, the present invention prompts the client account to select a desired time period from the at least one available time period. The appointment module is important to avoid any conflicts that can arise between the client and the tax preparer when setting up an appointment. When the client account selects the desired time period, the present invention reserves the desired time period within the appointment schedule. In order to complete the reservation of the desired time period, the present invention forwards an appointment notification to the tax preparer account regarding the desired time period. Therefore, both the client account and the tax preparer account have a mutual agreement on the desired time period.

The present invention provides a list of branch locations for the tax preparer account. The list of branch locations is also intended to provide additional convenience to the client. More specifically, the list of branch locations allows the client account to decide which branch location the personal information and the required tax information is sent to. In order to do so, the present invention initially displays the list of branch locations to the client account through the mobile interface. Next, the client account is prompted to select a primary location from the list of branch locations. The primary location varies from one client account to the other. When the client account selects the primary location, the tax preparer account is notified regarding the selection of the client account. As a result, all exchanges between the tax preparer account and the client account are completed through the primary location.

The tax preparer account receives a service charge from the client account for the services offered to the client account. In order to reduce the service charge, the tax preparer account provides a list of available coupons. Each of the available coupons has a different offer which reduces the service charge of the tax preparer account. The list of available coupons is displayed to the client account through the mobile interface which allows the client account to select a desired coupon from the list of available coupons. When the desired coupon is selected, the present invention applies the desired coupon to the service charge. Resultantly, the service charge is reduced for the client account.

The present invention is intended to be used by a variety of tax preparers. In order to differentiate one tax preparer account from another, the mobile interface is customized with a plurality of design graphics that is unique to the tax preparer account. For instance, the plurality of design graphics includes the logo of the tax preparer account. Resultantly, the client account promptly gets an idea of the tax preparer account. If the tax preparer profile intends on making modifications to the plurality of design graphics, the modification can be applied through the backend interface. Since the web interface and the mobile interface are communicably linked through the backend interface, any modification on the web interface is reflected on the mobile interface.

In utilizing the present invention, the proceeding process flow is followed. Primarily, the client account accesses the present invention through the mobile interface. The mobile interface allows the client account to enter personal information such as name, social security number, and dependant information. Furthermore, the client account also uploads digital photographs of the at least one identification card and the received tax documentation through the mobile interface. All information is stored on the secure server. When stored on the secure server, the tax preparer account is notified regarding the submission by the client account. The tax preparer account accesses the secure server in order to obtain necessary documents for the tax filing process. In order to do so, the tax preparer account utilizes the web interface. The encrypted submission identification number ensures that the personal information and the required tax information are directly sent to the tax preparer account. When the tax preparer account enters the encrypted submission identification number, the present invention decrypts the encrypted submission identification number to display the personal information and the required tax information extracted from the digital photographs. As a result, the tax preparer account can conveniently review the personal information and the required tax information through the website interface and proceed to filing the tax return.

Although the invention has been explained in relation to its preferred embodiment, it is to be understood that many other possible modifications and variations can be made without departing from the spirit and scope of the invention as hereinafter claimed.

What is claimed is:

1. A method for submitting and receiving tax related information on a portable computing device by executing computer-executable instructions stored on a non-transitory computer-readable medium, the method comprises the steps of:
providing a mobile interface and a website interface;
communicably linking the mobile interface and the website interface through a secure server;
providing a client account and a tax preparer account;
prompting the client account to enter personal information and receiving the personal information through the mobile interface;
receiving digital photographs of an at least one identification card and received tax documentation through the mobile interface;
storing the personal information and the digital photographs of the at least one identification card and the received tax documentation on the secure server;
scanning and extracting required tax information from the digital photographs of the at least one identification card and the received tax documentation;
notifying the tax preparer account to review the personal information and the required tax information;
displaying the personal information and the required tax information to the tax preparer account through the website interface;
prompting the tax preparer account to review and edit the personal information and the required tax information; and
submitting a tax report compiled from the personal information and the required tax information.

2. The method for submitting and receiving tax related information on a portable computing device by executing computer-executable instructions stored on a non-transitory computer-readable medium, the method as claimed in claim 1 further comprises the steps of:
generating an encrypted submission identification number from the personal information and the required tax information;
forwarding the encrypted submission identification number to the tax preparer account in order to notify the tax preparer account to review the personal information and the required tax information;
prompting the tax preparer account to enter the encrypted submission identification number through the website interface;
decrypting and verifying the encrypted submission identification number with the personal information and the required tax information;
retrieving the personal information and the required tax information from the secure server; and
displaying the personal information and the required tax information to the tax preparer account through the website interface.

3. The method for submitting and receiving tax related information on a portable computing device by executing computer-executable instructions stored on a non-transitory computer-readable medium, the method as claimed in claim 1 further comprises the steps of:
searching through the personal information and the required tax information for missing fields and/or incorrect information before submitting the tax report;
displaying an error message to the tax preparer account,
if missing fields and/or incorrect information are found within the personal information and the required tax information;
receiving corrections for the missing fields and/or the incorrect information from the tax preparer account through the website interface; and
submitting the tax report compiled from the personal information and the required tax information with the corrections.

4. The method for submitting and receiving tax related information on a portable computing device by executing computer-executable instructions stored on a non-transitory computer-readable medium, the method as claimed in claim 1 further comprises the steps of:
providing a preparer profile for the tax preparer account;
providing a backend interface, wherein the mobile interface and the website interface are communicably linked through the backend interface;
receiving updates for the preparer profile through the backend interface; and
displaying the preparer profile with the updates to the client account.

5. The method for submitting and receiving tax related information on a portable computing device by executing computer-executable instructions stored on a non-transitory computer-readable medium, the method as claimed in claim 1 further comprises the steps of:
providing an appointment schedule for the tax preparer account;
displaying at least one available time period from the appointment schedule through the mobile interface to the client account;
prompting the client account to select a desired time period from the at least one available time period;
reserving the desired time period within the appointment schedule; and
forwarding an appointment notification for the desired time period to the tax preparer account.

6. The method for submitting and receiving tax related information on a portable computing device by executing computer-executable instructions stored on a non-transitory computer-readable medium, the method as claimed in claim 1 further comprises the steps of:
providing a list of branch locations for the tax preparer account;
displaying the list of branch locations to the client account through the mobile interface;
prompting the client account to select a primary location from the list of branch locations; and
notifying the tax preparer account of the primary location selected by the client account.

7. The method for submitting and receiving tax related information on a portable computing device by executing computer-executable instructions stored on a non-transitory computer-readable medium, the method as claimed in claim 1 further comprises the steps of:
providing the tax preparer account with a service charge paid by the client account;
displaying a list of available coupons to the client account through the mobile interface;
prompting the client account to select a desired coupon from the list of available coupons; and
reducing the service charge paid the client account by applying the desired coupon to the service charge.

8. The method for submitting and receiving tax related information on a portable computing device by executing computer-executable instructions stored on a non-transitory computer-readable medium, the method as claimed in claim 1 wherein, the mobile interface is customized with a plurality of design graphics unique to the tax preparer account.
